(19) United States
(12) Patent Application Publication
(10) Pub. No.: US 2011/0228270 A1
(43) Pub. Date: Sep. 22, 2011

(54) Open-Path Near Real-Time Full Wall Emissions Monitoring Method

(76) Inventors: William Walker, Palatine, IL (US); Larry Golden, Palatine, IL (US); Amy Karony, Palatine, IL (US)

(21) Appl. No.: 12/727,415

(22) Filed: Mar. 19, 2010

(51) Int. Cl. G01J 3/28

(52) U.S. Cl. 356/326

(57) ABSTRACT

The invention is a combination of two prior arts (one being a tower elevator system and the other an open-path monitoring system) in order to perform automated “full wall” monitoring of an emission source. The system will allow an open-path detection system to take near real-time readings of the compounds present in the full area between the towers (both rectangular and triangular areas as shown in FIG. 1) by allowing either the retroreflector, or both the retroreflector and an open-path monitoring device to traverse the height of the towers. Sampled air is continuously monitored as the instrument traverses the tower. This is essentially a method for obtaining the impact of an emission source on the environment by acquiring a virtual “wall” of sampled air through automated and synchronized vertical movement and operation (both upstream and downstream of the source) of an open path detection method.

### BACKGROUND OF THE INVENTION

Long range open path fence-line monitoring has been used in attempts to retrieve the complete list and quantity of emissions leaving a plant facility for quite some time. Several measurement techniques have been employed to do this including Fourier-Transform Infrared Spectroscopy (FT-IR), Long path ultra violet (UV), Light Detection and Ranging (LIDAR) and others. One shortcoming of all these techniques as they are currently deployed is that they all only give the user a reading of the contaminants contained in a single fixed beam path. By vertically synchronizing traveling sources and reflectors our invention substantially increases the effectiveness and usability of any and all of these measurement techniques. Vertical Synchronization is performed using Tower Elevator Systems, developed by Tower Systems Inc. (TSI). (Related Patents: U.S. Pat. No. 5,309,217; DE 4212143; U.S. Pat. No. 5,923,422; DE 19704598, U.S. Pat. No. 7,501,629)

### FT-IR

FT-IR (Fourier-Transform Infrared Spectroscopy) is a technology used to identify the types and quantities of chemicals in a sample of air. It is done by collecting the spectra response of a pulse from some type of electromagnetic radiation and comparing this response to a library of known compounds. This radiation could be gamma-rays, x-rays, UV-visible, infrared, or magnetic.

### Long Path UV

Long Path UV spectroscopy is another technology which is used to identify the types and quantities of chemicals in a sample of air. UV spectroscopy works similarly to open path FTIR spectroscopy by sending a UV beam to a retroreflector. This beam contains many different specific colors, and each element and molecule in the atmosphere absorbs specific frequencies of light. The detector recognizes which frequencies are not returning and can judge the type and quantity of elements in the space between it and the retroreflector.

### LIDAR

LIDAR, or Light Detection And Ranging, is another optical remote sensing technology that uses laser pulses to find information about the atmosphere between it and a distant reflector. LIDAR records the time it takes for the emitted pulse to return to the detector and this information can tell the user valuable information about the area between the sensor and the reflector.

### Tower Elevator System

Tower Systems Inc. (TSI) has developed a tower elevator system which includes a power-driven carriage on which any type of instrument can be mounted. This carriage is able to hold up to 100 lbs. and can supply electricity to the instrument of choice. The carriage offers smooth travel even in severe weather and provides high stability at any height on the tower. Tower elevator systems can move up and down the tower on their tracks at 22 to 25 ft/min and this speed is tunable for synchronization. The average open-path instrument weighs 60 to 80 lbs. and will easily fit on and be supported by both the TS-2000 and TS-2500 elevator systems from TSI.

### BRIEF SUMMARY OF THE INVENTION

This rectangular “full wall” or triangular “half wall” monitored area has dimensions limited by the tower height and the distance over which the open path instrument can sample (which is limited by the amount of carbon dioxide and water vapor between it and the retroreflector) as well as the speed at which the tower elevators can travel (between 22-25 ft/min). The tower elevators will perform sweeps, in sync, up and down the towers on the elevators and take readings as they traverse creating a virtual “full wall” of monitored samples. This type of monitoring provides much more detailed information about the environmental impact of a plant or single emission source than a single site-line as is now the norm. Using the the concentration measurements obtained by this method, one can obtain either a portfolio of the height-averaged concentrations of compounds being emitted from the source, or a height profile of the compounds and their concentrations being emitted at each height. This type of monitoring can be aligned to measure the emission spectrum coming from a single plume, as seen in FIG. 2, or for an entire factory of compound emissions spectra, FIG. 3.

### DETAILED DESCRIPTION OF THE INVENTION

For the case of a single plume, three towers are utilized and each tower is located at the corner of a triangle surrounding the plume. One of the towers includes an elevator which carries the signal instrument, one includes an elevator carrying the detection instrument, and the last tower includes an elevator which carries both. This configuration can be seen in more detail in FIG. 2. All Elevators must be aligned at the same height to start the data collection and are synchronized as they travel up the towers. The triangle formed by the towers must be situated so that the side that is the line between the tower with only a signal instrument and the tower with only a detector instrument is as parallel as possible to ambient airflow. That is to say that one system will be measuring upstream of the plume, and one system will be measuring downstream of the plume. To get the most accurate impact of the emission source, the two legs of the triangle on which measurements are being done should be as close to parallel as possible while still surrounding the plume. This type of configuration could be used to calculate the spectrum of pollutants coming from an individual plume.

For the case of verifying an entire compound's emission spectra, four or more tower elevators are required. In the case of four towers, two tower elevators carry the signal instrument, and two carry the detection instrument. One pair of towers (one with a signal instrument, and one with a detection instrument) is used to verify the upstream airflow concentrations, and one pair verifies the downstream airflow concentrations. If conditions are such that one open-path monitoring device cannot monitor over the entire length of the facility, more than open-path monitoring device should be used on both the upstream and downstream sides of the facility. This type of configuration could be used to calculate the complete spectrum of pollutants coming from a compound.

The reason that upstream and downstream concentrations are monitored is to be able to obtain a mass flow rate of the compounds entering the facility's perimeter and a mass flow rate of the compounds exiting the facility's perimeter. The mass flow rate can be found by utilizing the concentration found by open-path monitoring, the wind speed of the location, and the molecular weight of each compound found. From this, one can calculate the mass flow rate of each compound that the facility itself is emitting. This result can be used for EPA standard compliance, legal issues, and many other uses.

### BRIEF DESCRIPTION OF SEVERAL VIEWS OF THE DRAWINGS

FIG. 1 depicts a view of the spectrometer/reflector system as if the viewer was a person looking at it from upstream of downstream of the source. Each tower will contain an elevator system with either a spectrometry instrument or a reflecting instrument. Both towers can either rise or be lowered (as shown by the dashed lines) in synchronization or solely the reflecting instrument is in vertical motion, and the spectrometer is rotated to follow that movement. In the case of both instruments moving together, the sampled area is the entire rectangle, and in the case of only the reflector moving, the sampled area is the lower triangle.

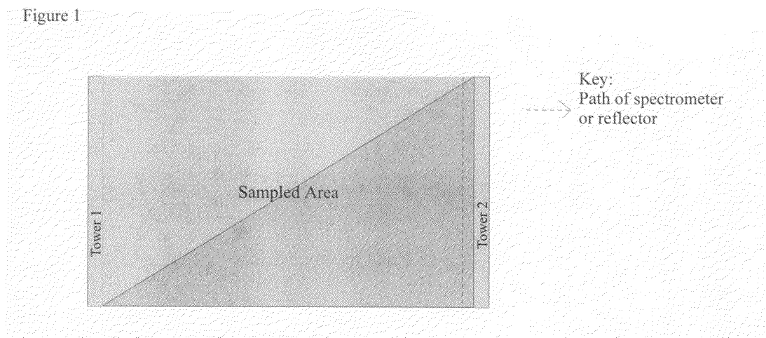

FIG. 2 is a bird's eye view of the monitoring system for a single emission source such as a plume. The plume is situated in the middle of the triangle, and each tower elevator system is represented a triangle. Airflow is indicated by the arrows, and reflectors and spectrometers are represented by the shapes shown in the key. The path of the spectrometer signal is represented by the dashed line.

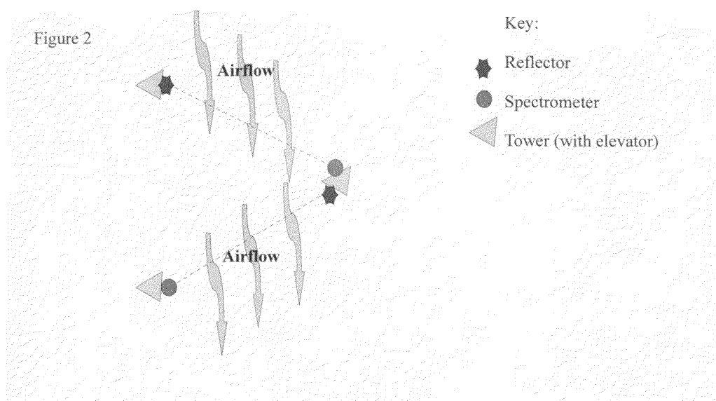

FIG. 3 is a bird's eye view of the monitoring system for a large emission source such as a factory or compound. Airflow, reflectors, spectrometers, and spectrometer path are all represented in the same way as they are in FIG. 2.

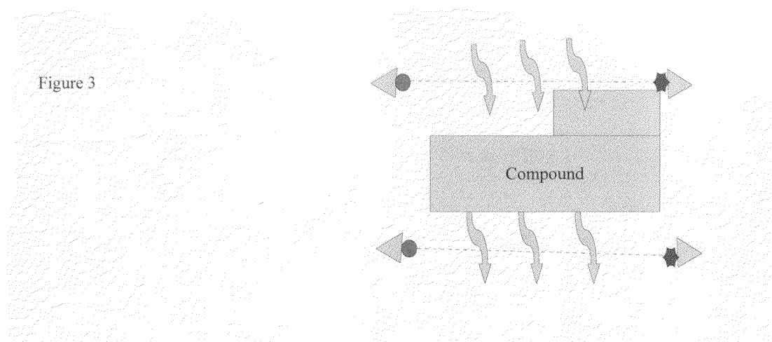

What is claimed is:

1. An integrated approach for determining the specific impact of an entire emission source on the atmosphere downstream of the source, including
A method for obtaining essentially a “full wall” of near real-time monitored air using automated and synchronized vertical movement and operation of an open-path detection method over a distance across which air sampling is required
Concurrent vertical movement of two sampling systems, one upstream and one downstream of an emission source

2. Optionally, using fixed transmitters and vertically traveling retroreflectors to obtain the same “full wall” measurement effect
